(19) United States
(12) Patent Application Publication
(10) Pub. No.: US 2022/0228877 A1
(43) Pub. Date: Jul. 21, 2022

(54) ELECTRIC VEHICLE CHARGING SYSTEMS, METHODS, AND TECHNIQUES

(71) Applicant: Enel X North America, Inc., Boston, MA (US)

(72) Inventors: Daniel Feldman, New York, NY (US); Amanpreet Kaur, San Francisco, CA (US); Jenya Kirshtein, Menlo Park, CA (US)

(21) Appl. No.: 17/648,402

(22) Filed: Jan. 19, 2022

Related U.S. Application Data
(60) Provisional application No. 63/139,593, filed on Jan. 20, 2021.

(51) Int. Cl. G01C 21/34; B60L 53/66; B60L 53/67

(52) U.S. Cl. CPC G01C 21/3476; G06Q 10/047; B60L 53/67; B60L 53/66

(57) ABSTRACT

Techniques for activating charging stations for an EV driver are disclosed. A charging station authorization system of an electric mobility service provider (eMSP) may receive information from an EV driver describing an electric vehicle (EV), preferences, constraints and trip information. The charging station authorization system may determine one or more routes for the trip that include use of charging stations owned or operated by Charge Point Operators (CPOs) during the trip and fit within the constraints. The charging station authorization system may order, based on costs of using charging stations, the routes, and/or recommend use of a route. Based on a EV driver selection and/or authorization, the charging station authorization system may send a request to one or more CPO computing systems to authorize charging by the EV driver of an EV at charging stations along the selected route.

### CROSS-REFERENCE TO RELATED APPLICATIONS

The present application claims the benefit of priority under 35 U.S.C. Section 119(e) of U.S. Provisional Patent Application No. 63/139,593, entitled ELECTRIC VEHICLE CHARGING SYSTEMS, METHODS, AND TECHNIQUES, filed Jan. 20, 2021, which is hereby incorporated herein by reference in its entirety.

### TECHNICAL FIELD

The present disclosure generally relates to the field of electric vehicle charging. More particularly, systems, methods, and techniques for authorizing, activating, or otherwise provisioning electric vehicle (EV) charging for charging points within an electric mobility service provider (eMSP) network serviced by Charge Point Operators (CPOs) are disclosed.

### BRIEF DESCRIPTION OF THE DRAWINGS

The present embodiments will become more fully apparent from the following description, taken in conjunction with the accompanying drawings. Understanding that the accompanying drawings depict only typical embodiments, and are, therefore, not to be considered limiting of the scope of the disclosure, the embodiments will be described and explained with specificity and detail in reference to the accompanying drawings.

FIG. 1 shows a communication diagram of a system providing electric vehicle charging authorizations, according to some embodiments.

FIG. 2 shows an example of electric vehicle geographic routing options and constraints, according to some embodiments.

FIG. 3 shows an example of a mobile screen describing geographic routing options, according to some embodiments.

FIG. 4 shows a system diagram of a system providing electric vehicle charging authorizations, according to some embodiments.

FIG. 5 shows a vehicle driver profile, according to some embodiments.

FIG. 6 shows a flow diagram of a process of authorizing vehicle charging for a starting location to a destination, according to some embodiments.

FIG. 7 shows a flow diagram of a process of authorizing vehicle charging using geographical timing data, according to some embodiments.

FIG. 8 shows a flow diagram of a process of authorizing vehicle charging, according to some embodiments.

FIG. 9 illustrates a method of a computing device for activating charging stations, according to an embodiment.

FIG. 10 illustrates a method of a computing device for activating charging stations, according to an embodiment.

FIG. 11 shows a diagram of a computing system of a system providing electric vehicle charging authorizations, according to one embodiment.

### DETAILED DESCRIPTION

The automotive industry is investing heavily to deliver new electric vehicle (EV) models, from research and development to factory redesign. Consumer attitudes about EVs are continuing to evolve and EV sales are increasing. An important challenge the industry is addressing is providing electric vehicle service equipment (EVSE) for charging the increasing number of EVs in use, particularly during trips that exceed the power of a single charge of an EV's battery capacity.

Scarcity of EVSE and time required to recharge the battery(ies) of an EV make recharging an EV somewhat more complicated than refueling a traditional internal combustion engine vehicle. These challenges have led to elaborate schemes and methods for coordinating EV charging. Some presently available systems of provisioning EVSE for EV charging can include routing algorithms to systematically plan EV charging events at different EVSE locations along a trip. Presently available systems of provisioning EVSE typically take into consideration one of two constraints: namely optimal time to destination (including charging time) or minimum distance travelled (which can translate to minimum energy spent). Presently available systems of provisioning EVSE normally do not consider tariffs (i.e. different combination of price per kwh, and or connection time) or other operator interoperability considerations that impact a cost of charging. As EVSE locations become increasingly ubiquitous, a driver and/or an electric mobility service provider (eMSP) may desire optimizing a cost of charging in provisioning EVSE along a route of a trip on an EV.

Systems, methods, and techniques for authorizing, activating, or otherwise provisioning charging stations for EV charging are disclosed. A charging station authorization system of an eMSP, according to some embodiments of the present disclosure, may receive information describing an EV, preferences, constraints and trip information. The charging station authorization system may determine one or more routes for the trip that include use of charging stations owned or operated by Charge Point Operators (CPOs) during the trip and fit within the constraints. In some embodiments, the charging station authorization system may have and/or have access to relationship data describing that this eMSP is entitled to one or more privileges (e.g., reduced pricing, more liberal charging restrictions) when using charging stations of certain CPOs, and may further have and/or have access to operator data regarding ownership and/or some other form of control or entitlement of those CPOs that allows those CPOs to control operation of and/or charge for the use of particular charging stations. In such embodiments, the determination of the one or more routes may use the relationship data and/or the operator data to determine particularized costs data for charging stations of these CPOs relative to the relationship between the eMSP and the CPOs. The charging station authorization system may order, based on costs of using charging stations, the routes, and/or recommend use of a route. Based on a user selection and/or authorization, the charging station authorization system may send a request to one or more CPO computing systems to authorize charging of the EV at charging stations along the selected route.

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

Moreover, the phrases “connected to” and “coupled to” are used herein in their ordinary sense, and are broad enough to refer to any suitable coupling or other form of interaction between two or more entities, including mechanical, fluid, and thermal interaction. Two components may be coupled to each other even though they are not in direct contact with each other. The phrase “attached to” refers to interaction between two or more entities which are in direct contact with each other and/or are separated from each other only by a fastener of any suitable variety (e.g., an adhesive, etc.).

The terms “a” and “an” can be described as one, but not limited to one. For example, although the disclosure may recite an element having, e.g., “a line of stitches,” the disclosure also contemplates that the element can have two or more lines of stitches.

Unless otherwise stated, all ranges include both endpoints and all numbers between the endpoints.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment. Not every embodiment is shown in the accompanying illustrations; however, at least a preferred embodiment is shown. At least some of the features described for a shown preferred embodiment are present in other embodiments.

The term electric vehicle (“EV”), as used herein, refers to a motorized vehicle deriving locomotive power, either full-time or part-time, from an electric system on board the motorized vehicle. By way of non-limiting examples, an EV may be an electrically powered passenger vehicle for road use; an electric scooter; an electric forklift; a cargo-carrying vehicle powered, full-time or part-time, by electricity; an off-road electrically powered vehicle; an electrically powered watercraft; etc. It should be recognized that systems of an EV may include external devices, such as mobile device (e.g., cell phone, tablet, laptop, computer, etc.). For example, a mobile device may be coupled to the EV via Bluetooth™ and communicate with the EV, charging station, and/or other computer platforms to arrange and enable charging at a charging station. Such external devices are contemplated and included when describing an EV unless otherwise disclaimed.

The term electric vehicle supply equipment (“EVSE”), as used herein, refers to equipment by which an EV may be charged or recharged. An EVSE may comprise or be coupled to a computing system whereby service to the EV is provisioned, optionally, according to operator-selectable parameters. An EVSE may comprise a means of providing cost accounting, and may further comprise a payment acceptance component. An EVSE may be installed at a home of an owner/operator of an EV, at a place of business for an owner/operator of an EV, at a fleet facility for a fleet comprising one or more EVs, at a public charging station, etc. The present disclosure uses the terms EVSE and “charging station,” where for purposes of this disclosure, an EVSE is an example of a charging station.

The term Charge Point Operator (CPO), as used herein, refers to an entity and/or the computing resources of the entity that provide EVSE(s) and/or charging station(s) to charge EVs. The CPO may own, lease, and/or operate one or more charging stations. The CPO may receive, from the eMSP in the present or future, a request to charge. When referring to the CPO within a technical description, it is understood that the CPO computing resources (e.g., computing platform, computing service) are performing the action and not the entity or a person within the entity. For example, the CPO sending a message to the charging station is viewed as a CPO computing platform transmitting data to a charging station.

The term electric mobility service provider (eMSP) or mobility service provider (MSP), as used herein, refers to an entity and/or the computing resources of the entity that manages users and gives user access to charging stations that are managed by CPOs. In some cases, an eMSP may also act as a CPO and/or contract with other CPOs. An eMSP may have different pricing from different CPOs and/or for each charger that a CPO operates. In some embodiments, an eMSP may offer “flat pricing” to users, which may cause an eMSP to make more or less money depending on routing of users to specific charging stations. When referring to the eMSP within a technical description, it is understood that the eMSP computing resources (e.g., computing platform, computing service) are performing the action and not the entity or a person within the entity. For example, the eMSP sending a message to a user is intended to be understood as an eMSP computing platform transmitting data to a user device associated with an eMSP account and/or an associated electric vehicle.

While many presently available routing systems may be constrained by optimal time and/or minimum distance travelled, EVs may have additional parameters and/or desired outcomes than a typical routing system may use. EV routing systems may consider variables such as state of charge (SoC), weather, inclination, average speed, traffic, charging time of EVSEs. However, presently available routing for EVs may lack additional considerations, such as optimizing for cost within constraints (e.g., maximum trip duration). These constraints may include factors for EVSE utilization at a location, EVSE load balancing at a location, and contract cost to an eMSP. Embodiments of the present disclosure may provision EVSE by providing recommended routing for a trip, based on additional considerations such as optimizing for cost within constraints (e.g., maximum trip duration).

An advantage of some of the disclosed embodiments is that a competitive cost optimized service to customers may be provided when charging within an eMSP provided network. An EV driver may have an account with a eMSP that covers one or more EVs. The account may be operable through a mobile device that is separate from the one or more EVs or may include connectivity to the one or more EVs. If the EV driver uses the account with systems outside of the coverage area, additional costs may occur. The system may enable a high priority (which may be guaranteed) in charging and/or comparatively shorter wait time, which may be tied to a premium. An eMSP may use contracts with various CPOs that enable the system to ensure a sufficiently high charge rate, reliable service, uptime of chargers, wait-time, type of chargers (Level 1, 2, or 3), AC or DC chargers, etc. An eMSP utilizing a disclosed embodiment may offer, to its EV drivers, a fixed flat rate or variable rate. The eMSP system may also provide full routing service for EV drivers to minimize an EV's cost of charging for a given trip, which may provide benefits when the EV driver is under a variable pricing plan. A routing system may use a routing application that includes an algorithm and/or heuristics to recommend the route and stops to the EV driver by evaluating usage information, CPO, traffic, and/or network conditions. The EV driver may share their start location, destination, EV model, etc., and the CPO may be broadcasting the real-time charge prices (if applicable), available chargers, their specs, site line constraints, etc. The disclosed embodiments may use the OCPI protocol to broadcast and/or receive such information/data.

The methods and techniques of the foregoing embodiments may be extended to commercial users, such as by providing services for electric fleet management, including routing and managing a supply chain. Special tariff structures (fixed or variable) for fleet customers may be used by eMSP systems by determining various CPOs available in a region of interest, electric fleet charge needs, etc. Constraints may include delivery commitments, transit times, available resources, daily drive requirements, etc. The disclosed embodiments may then compute optimal route(s) for a fleet with an objective of minimizing operational costs for the operator while meeting the constraints. The disclosed embodiments may utilize charging locations, constraints on EV batteries, weather parameters, speed requirements, etc. Fleet based routing of the disclosed embodiments may additionally account for urgency and flexibility in resource planning, such as new requests, updates, available backup resources, etc. so that the routes may be dynamically altered after initial planning. This dynamic management may enable lower costs to customers and more efficient use of EV charging networks.

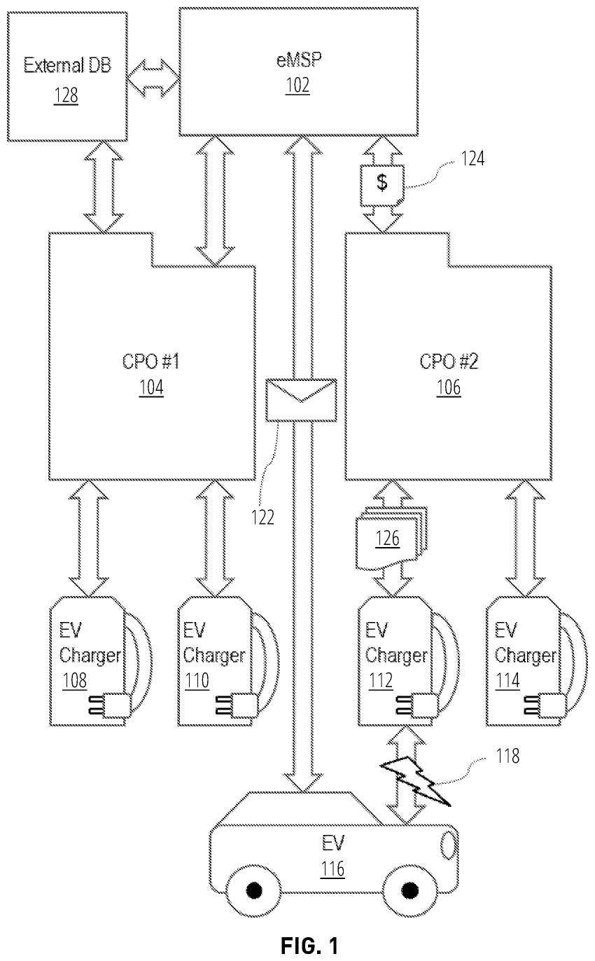

FIG. 1 shows a communication diagram of a system for provisioning EVSE, according to embodiments of the present disclosure, that provide electric vehicle charging authorizations. Systems of an eMSP 102 may be in communication with an EV 116 and one or more CPOs 104, 106. In some embodiments, the eMSP 102 may also be in communication with an external DB 128. CPO systems 104, 106 may be in communication with one or more charging stations 108, 110, 112, 114. In some embodiments, either of the CPO systems 104, 106 may be in communication with an external DB 128 (in FIG. 1, the CPO #1 104 has been illustrated in communication with the external DB 128, but other CPOs such as the CPO #2 106 could (also or alternatively) be in communication with the external DB 128 in other embodiments). The EV 116 may be in communication with the eMSP 102 and a charging station 112. The communication and/or networking together of these systems may allow the EV 116 (or an operator thereof) to subscribe and/or pay for charging services provided by a CPO (e.g., one or more of the CPOs 104, 106) through a single eMSP 102.

The eMSP 102 and CPOs 104, 106 may communicate in order to enable the eMSP to enable charging stations 108, 110, 112, 114 for use with the EV 116 and other EVs that use the eMSP services. The eMSP 102 may recommend and/or route the EV 116 and the other EVs to charging stations 108, 110, 112, 114 that maximize value for customers of the eMSP 102. Value may be defined in minimizing cost while accounting for travel time, distance, charging time, scheduling, and/or other constraints. Benefits and costs may be different for each charging station 108, 110, 112, 114.

In some of these cases, the eMSP 102 may have access to relationship data providing information about one or more CPOs 104, 106, with which the eMSP 102 has a relationship (e.g., a formal/express relationship, association, or affiliation). This relationship may be more than simply an awareness at the eMSP 102 of the existence and/or usability of the CPOs 104, 106, but rather may indicate some form of concerted, particular agreement or arrangement as between the eMSP 102 with the CPOs 104, 106 (e.g., beyond mere awareness or knowledge of basic availability of the charging stations associated with CPOs for general charging). The relationship data may specify or otherwise indicate privileges or benefits the eMSP 102 may have with respect to CPOs 104, 106 according to this relationship, including preferred or otherwise privileged charging windows (hours of a day, days of a week, etc.) with respect to timing and/or pricing, and/or privileged pricing or costs information (e.g., a reduced price purely based on the relationship of the eMSP 102 with a CPO 104, 106, with or without respect to timing). Such a relationship between the eMSP 102 and a CPO 104, 106 reflected by/described by the relationship data may be based on a contract, subscription, rewards network, loyalty program, etc., that corresponds to the use of the eMSP 102 by the EV 116 (or a user of the EV 116) for charging the EV 116 as with any charging station 108, 110, 112, 114 of a CPO 104, 106 so related with the eMSP 102.

This relationship data may be provided to the eMSP 102 from an outside source. For example, it may be that the eMSP 102 may communicate with a CPO 104, 106 in order to establish a new such relationship and/or to determine whether the CPO understands itself to be in such a relationship with the eMSP 102.

In other embodiments, the external DB 128 may provide this relationship data. The external DB 128 may be an external database or information resources to the eMSP 102 and/or the CPOs 104, 106, and may be managed by a third party to the parties operating either/both of the eMSP 102 and/or the CPOs 104, 106. The external DB 128 may have a copy of the relationship data reflecting relationships between the eMSP 102 and the CPOs 104, 106 that can be accessed by the eMSP 102. It is contemplated that this relationship data as found at the external DB 128 may have been provided to the external DB 128 originally by, in some embodiments, the CPOs 104, 106 themselves, or by the parties operating the CPOs 104, 106.

The eMSP 102 may access the relationship data to determine any relationship(s) the eMSP 102 may have with any CPOs, and any privileges (e.g., pricing) accompanying such relationship(s). In other words, the benefits and costs associated with EV 116 and/or the user of the EV 116 of one or more of the charging station 108, 110, 112, 114 may be derived from contracts and/or relationships between the eMSP 102 and CPO 104, 106 as reflected in the relationship data. For example, the eMSP 102 may have access to operator data for the CPOs 104, 106 with which it is related per the relationship data. This operator data may indicate that such a CPO owns (or is otherwise entitled to operate and/or assess charges for the use of) a charging station. For example, in the embodiment shown in FIG. 1, the operator data at the eMSP 102 may indicate that the CPO #1 104 operates the charging station 108 and the charging station 110, and that the CPO #2 106 operates the charging station 112 and the charging station 114.

This operator data may be provided to the eMSP 102 from an outside source. For example, it may be that the eMSP 102 may communicate with a CPO 104, 106 in order to obtain the operator data for the CPO 104, 106.

In other embodiments, the external DB 128 may provide this operator data. The external DB 128 may have a copy of the operator data, which reflects ownership or other right(s) to operate and/or assess charges at the charging stations 108, 110, 112, 114, by the CPOs 104, 106. It is contemplated that this operator data as found at the external DB 128 may have been provided to the external DB 128 originally by, in some embodiments, the CPOs 104, 106 themselves, or by the parties operating the CPOs 104, 106.

Using this operator data, the eMSP 102 may determine that any special pricing, cost, or other benefit or privilege (such as privileged charging windows) that the eMSP 102 may secure relative to a relationship with the CPO 104, 106 as reflected in the relationship data should apply at those owned/operated charging stations 108, 110, 112, 114. The relationship data and the operator data together may thus be understood to useable together to generate cost data for one or more charging stations to be used along a route that is particular to the use of the eMSP 102 by the EV 116 (or a user of the EV 116) in the manner described.

This information can be used during routing for the EV 116. For example, the value of a route (e.g., based on minimized total cost across used charging stations on that route under/within certain constraints, as described herein) may be more accurately understood based on any cost that applies at one or more charging stations used along the route due to the relationship of the eMSP 102 with the CPO 104, 106 that operates one or more of the charging stations along the route (e.g., may be less expensive than a default case where an understanding of any relationships and subsequent beneficial pricing available through the relationships of the eMSP 102 with the CPOs 104, 106 is not used). In this manner, the use by the EV 116 (and/or the user of the EV 116) of the relationships of the eMSP 102 may offer better pricing along routes and/or may even cause one route to be more desirable than another (e.g., as compared to the described default case).

The use of relationship data and operator data in the manner described is not required, in that some embodiments operate according to the described default case, where the cost of operating a particular charging station 108, 110, 112, 114, is not improved or changed due to a relationship between the eMSP 102 and the relevant CPO 104, 106. In other words, it is contemplated that embodiments described herein not using relationship data and/or operator data would still be operative to minimize costs of a route using, for example, “public” costs of the charging stations 108, 110, 112, 114 (e.g., that may be known to the eMSP 102 through communication with the CPOs 104, 106).

In some embodiments, an eMSP 102 may operate, function, or otherwise act as one or more CPOs 104, 106.

Customers may prefer to work with one eMSP 102, which reduces a number of sources for research (e.g., Applications on their mobile device) and removes a need to research which charging station to use. The eMSP 102, may then have a set of customers with EVs 116 that need charging. The CPOs 104, 106 may contract with the eMSP 102 to have access to the customers with EVs 116, in addition to other customers that may use the charging stations 108, 110, 112, 114. This enables the CPOs 104, 106 to access customers with EVs, the eMSPs 102 to access a larger network of charging stations 108, 110, 112, 114, and the customers to access a larger network of charging stations 108, 110, 112, 114 within a single point of contact (e.g., the eMSP 102 and/or a mobile application of the eMSP 102).

In an example, one or more CPOs 104, 106 may agree (e.g., contract) to provide services to EVs that are connected with (e.g., signed up with, have an account with, etc.) the eMSP 102. The eMSP 102 may receive a request 122 from an EV 116 (or a device associated with the EV 116) for a charger and/or route. The eMSP 102 may send options for charging stations 108, 110, 112, 114 (which may include details such as distance, cost, charging time, wait time, etc.) to the EV 116. The eMSP 102 may receive a route selection and/or charging station selection from the EV 116. The route selection and/or charging station selection that includes or otherwise corresponds to a charging station 112. The eMSP 102 may send an activation request to CPO #2 106 for authorizing or otherwise provisioning the charging station 112 to charge the EV 116. The EV 116 may arrive at the charging station 112 and exchange credentials with the charging station 112. The charging station 112 may communicate with CPO #2 106 before or after receiving the credentials (either pre-authorization or on-demand) and enable charging 118 of the EV 116 based on the activation request received by the CPO #2 106. The EV 116 may send a message confirming the charging to eMSP 102. The charging station 112 may send a message 126 to CPO #2 106 describing the charging of EV 116, including statistics about usage (time charging, power used, etc.). CPO #2 106 may send a message 124 to the eMSP 102 confirming the charging and/or invoicing eMSP 102 for the charges. The eMSP 102 may electronically pay (individually or in bulk) for usage for the CPO #2 chargers.

In some embodiments, the EV 116 includes a computing device. For example, the computing device may be a cellular phone, tablet computer, laptop computer, or the like. In some embodiments, the computing device includes global positioning system (“GPS”) circuitry configured to determine a current location of the computing device. In some embodiments, the computing device includes circuitry configured to determine a current location of the computing device using triangulation based on two or more wireless communication network access points for which respective locations are known. For example, each of the two or more wireless communication network access points may be a WIFI access point. In another example, each of the two or more wireless communication network access points may be a node of a mobile communication network (e.g., a cellular network such as GSM, LTE, 5G, or the like).

In some embodiments, the computing device is a computing device of a driver, occupant, or individual otherwise associated with the vehicle. In some embodiments, the computing device is in wireless or wired communication with the EV 116. For example, the EV 116 may include short range communication (e.g., Bluetooth) functionality where, for example, an onboard computing device of the EV 116 may transmit data to and/or receive data from one or more of the computing devices (e.g., via Bluetooth) located within a communication range of the vehicle. Similarly, the charging station 112 and/or the computing device may also include short range communication (e.g., Bluetooth) functionality and may each transmit data to and/or receive data from other computing devices (e.g., via Bluetooth) located within a communication range of the charging station 112 and/or the computing device, respectively. Each of the EV 116, charging station 112, and computing device may further each use a network for communication, as discussed below. In some embodiments, the computing device is configured to control charging of the EV 116 by the charging station 112 and/or determine an estimated SoC of the EV 116.

In some embodiments, the system includes one or more databases. For example, a database may store data from or used by one or more of the EVs 116, the charging station 112, the computing device. The data may be profile data for a vehicle driver reflecting information (e.g., make, model, VIN, Bluetooth MAC address, etc.) about one or more of the EV 116 operated by, owned by, or otherwise associated with the driver.

In some embodiments, system includes one or more other computing devices. For example, a computing device may be a remote computing device (e.g., a cloud computer or the like) that communicates with one or more of the EVs, the charging station 112, the computing device, and/or the database directly or via the network. In some embodiments, the computing device determines whether a particular user (e.g., vehicle driver, occupant, or person associated with the EV 116) is authorized to charge or have EV 116 charged at a particular charging station 112. For example, the computing device may process data (e.g., identification data, security token data, etc.) from the EV 116, the charging station 112, the computing device, and/or the database to determine whether a user is authorized to charge or have the EV 116 charged by the charging station 112. In some embodiments, the computing device is configured to control charging of the EV 116 and/or determine an estimated SoC of the EV 116. For example, the computing device may receive one or more of location data, SoC data, vehicle characteristics, and the like from the EV 116, the charging station 112, the computing device, and/or the database, and may determine an EV 116 SoC for use by charging station 112 when charging the EV 116.

In some embodiments, the system includes a network. For example, the network may be a cellular network, the Internet, a wide area network (“WAN”), a local area network (“LAN”), or any other type of communications network. In some embodiments, one or more of the EVs 116, the charging station 112, the computing device, the database, and/or the other computing devices use the network to communicate with each other and/or other computing devices. In some embodiments, each of the devices/elements of the system includes a network interface that allows for communication within the system via the network.

In some embodiments, the computing device communicates with the EV 116 and the charging station 112 directly (e.g., via Bluetooth or a different short range communication protocol) or indirectly via the network. In some embodiments, in addition or alternatively, the EV 116 and the charging station 112 communicate with each other directly (e.g., via Bluetooth or a different short range communication protocol) or indirectly via the network.

In some embodiments, the system is used to control charging of the EV 116 and/or estimate an SoC for the EV 116. For example, the charging control and/or SoC estimation may be performed by the computing device.

In some embodiments, the computing device may store a software application that facilitates estimating the SoC for the EV 116 and/or controlling charging of the EV 116. In some embodiments, the computing device may store location data and/or other data relevant to estimating the SoC of the EV. In some embodiments, the computing device may receive location data and/or other data relevant to estimating the SoC of the EV 116 from one or more of the EV 116, the charging station 112, the database, and/or the computing device. Alone or in combination with one or more of the EV 116, the charging station 112, the database, and/or the other computing device, the computing device may determine an estimated SoC for the EV 116. The computing device may then directly transmit the estimated SoC to the charging station 112 and/or transmit the estimated SoC to the charging station 112 via the network. In some embodiments, the computing device controls the overall charging of the EV 116 alone or in combination with the EV 116, the charging station 112, the database and/or the other computing device. Here, for example, the computing device may control the charging rate, amount, and/or duration of charging of the EV 116 by the charging station 112.

In some embodiments, charging by a charging station (e.g., charging stations 108, 110, 112, 114) is authorized using location data associated with the user's computing device. For example, the user's computing device may be in communication with a vehicle (e.g., EV 116) and may be used as a proxy for the location of a vehicle in relation to a charging station. In some embodiments, direct connectivity between the vehicle and the charging station is not necessary for charging authorization.

A computing device determines communicative connectivity with a vehicle to be charged (e.g., the EV 116). In some embodiments, the connectivity is Bluetooth connectivity. In some embodiments, a Bluetooth MAC address of the vehicle is matched to profile data for a vehicle driver reflecting information about the vehicle. In some embodiments, a process continues to block when the computing device determines that there exists communicative connectivity between the vehicle to be charged and the computing device.

The computing device may obtain or receive location data of the charging station. In some embodiments, the location data of the charging station includes GPS coordinate data of the charging station and/or triangulation (e.g., via WIFI) coordinate data of the charging station. The location data of the charging station may be received or obtained by the computing device directly from the charging station, indirectly from the charging station via a network, or from another computing device or from a database.

The computing device may compare location data of the computing device with the location data of the charging station to determine a location match. In some embodiments, GPS coordinate data of the computing device is compared to GPS coordinate data of the charging station to determine the location match. In some embodiments, triangulation coordinate data of the computing device (e.g., via WIFI) is compared to GPS coordinate data or triangulation coordinate data of the charging station to determine the location match. In some embodiments, the location match occurs when the coordinate data of the computing device and the charging station are the same or identical or within a threshold range of each other. For example, the threshold range may specify a particular distance (e.g., one foot, two feet, five feet, etc.) from the charging station within which the computing device may be located to cause a location match between the computing device and the charging station to occur. In some embodiments, a user places the computing device on the charging station or on a holder or stand of the charging station such that the computing device and charging station location data match. In some embodiments, the user need not open or otherwise access a particular application or software of the computing device for the comparison of location data to occur. In some embodiments, a process may continue to block when the computing device determines that the location match has occurred.

The computing device may authorize the charging station for charging a battery of the vehicle. In some embodiments, the authorization automatically occurs once the location match is determined (e.g., the locations of the computing device and the charging station are the same or identical or within a range). In some embodiments, the user is prompted to confirm location or provide some other user confirmation associated with the authorization (e.g., via interaction with a user interface of the computing device) and, after the confirmation, the computing device authorizes the charging station for the charging.

The charging station may provide electricity to the vehicle battery to charge the battery. It should be noted that the processes may be performed in whole or in part by a charging station 112, computing device, database, and/or charging station 112.

In some embodiments, the process may not require connectivity between the vehicle and the charging station, and may not require integration between an API of the vehicle and the charging station. In some embodiments, the process may not require specific pairing between the computing device and the charging station. For example, the computing device may obtain or receive location data from the charging station, or may obtain or receive location data reflecting the charging station's location from one or more other devices.

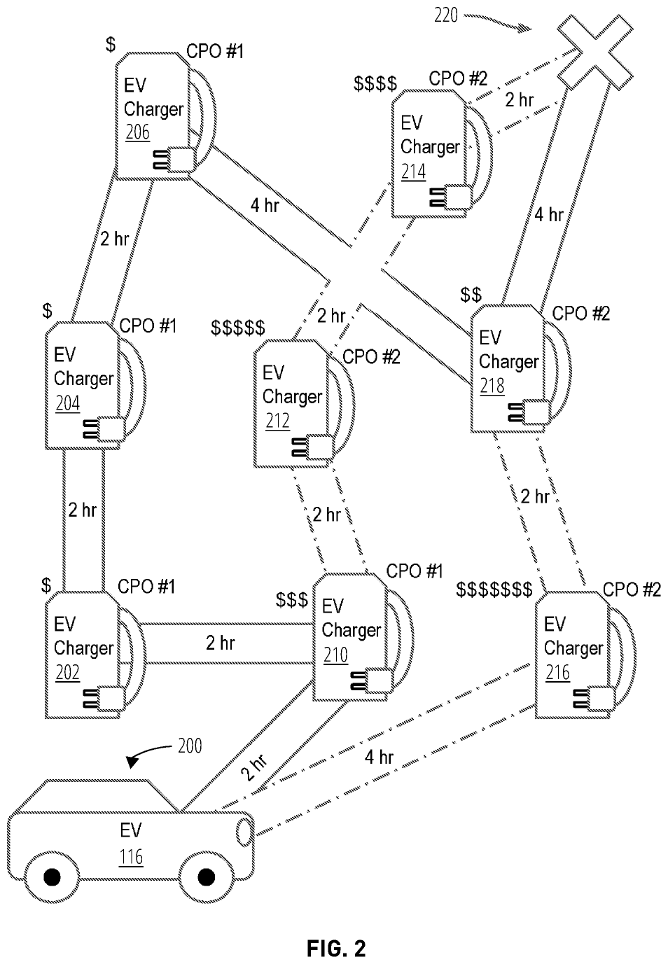

FIG. 2 shows an example of EV geographic routing options and constraints, according to some embodiments. An EV 116 may have a starting location 200 and a destination 220. The EV may have profile information, including range information and/or constraint information. The geography between the starting location 200 and destination 220 may comprise one or more charging stations 202-218. The charging stations 202-218 may be connected with roads or other transportation technology between them. These connections may be represented by an estimated time (or other estimated value, distance, etc.). The charging stations 202-218 may be owned and/or operated (managed, etc.) by a CPO (represented by a label, such as CPO #1 or CPO #2). The charging stations 202-218 may each have a cost (e.g., cost per kWh, total charging cost, etc. and represented by one or “$” to the upper left of the charging station symbol). This information may be stored, retrieved, and/or used by a charging station authorization system to determine which charging stations to authorize for use with an EV during a trip. In some embodiments, the cost of each of the charging stations 202-218 may be determined using, e.g., any relationship data and operator data, in the manner described herein.

In some embodiments, the data regarding charging stations 202-218 is received from one or more CPOs by an eMSP. The eMSP may provide the data to the charging station authorization system. The charging station authorization system may receive the starting location 200 and destination 220 from an EV 116 or a device related to the EV 116 (e.g., a mobile device of a user that drives the EV 116). The charging station authorization system may have received profile information from the EV 116 or the device related to the EV 116, that also may be stored for use. The profile information may include EV make, EV model, listed range, expected range, preferences (e.g., weights of preferences for lower elapsed time, lower cost, highways, city streets, geography to avoid, etc.) constraints (e.g., scheduling, lunch timing, total driving permitted per day, avoiding night driving, avoiding rush-hour traffic in cities, pick-up and drop-off, package capacity, etc.).

The charging station authorization system may determine one or more routes based on information received, including the EV starting location 200 and destination 220, the EV profile information, and charging station information. For example, a route from the starting location 200 to the destination 220 may use charging stations 210, 212, and 214. The route may have an estimated duration of 8 hours (2+2+2+2). The route cost may be weighted at a cost of 12 (3$+5$+4$). The route may use charging stations operated by both CPO #1 (210) and CPO #2 (212 and 214).

In an embodiment, the charging station authorization system may receive profile information of an EV, wherein the profile information comprises range data and constraint data, wherein the constraint data may comprise time duration limitation data. The charging station authorization system may receive charging station information. The charging station information may comprise geographic location data and cost data. The charging station authorization system may receive a starting geographic location of the EV and an ending geographic location of the EV. The charging station authorization system may estimate, based on time, a shortest route from the starting geographic location to the ending geographic location, the route comprising an expected duration of time. The charging station authorization system may determine a set of routes from the starting geographic location to the ending geographic location. Each route may comprise one or more charging stations enabling the EV to reach each charging station along the route based on the range data (e.g., meaning that each of the charging stations of the route is reachable by the EV, assuming that the EV is charged using the charging stations of the route). The charging station authorization system may delete, from the set of routes and based on the expected duration of time and time duration limitation data, one or more routes. The charging station authorization system may order, based on cost data of one or more charging stations included in a route, the set of routes. The charging station authorization system may transmit, for user selection, one or more of the ordered set of routes. The charging station authorization system may receive a user route selection from the ordered set of routes. The charging station authorization system may transmit a request to authorize charging of the EV with each of the charging stations included in a route from the set of routes indicated by the user route selection.

In the embodiment shown, the EV 116 may have an estimated range of five hours (although the range may be estimated in other ways, such as distance, power, etc.). Based on the range, the system may determine three routes that are compatible with the EV 116. A first route may use or otherwise include certain charging stations 210 and 214. A second route may use or otherwise include other charging stations 202, 206, and 218. A third route may use or otherwise include charging stations 216 and 218. The first route may include an eight hour duration, use of charging stations from CPO #1 and CPO #2, and a weighted cost value of 7. The second route may include 16 hour duration, use of charging stations from CPO #1 and CPO #2, and a weighted cost value of 4. The third route may include a 10 hour duration, use of charging stations from CPO #2, and a weighted cost of 9.

The charging station authorization system may use profile information and/or constraints with the route information to order the routes. For example, a profile may indicate that cost is of primary concern. With a weighted cost of 4, the 16 hour duration trip of the second route may be ordered first due to the much lower weighted cost. In another example, a constraint may be that the trip should be no longer than 2 hours of the shortest trip. This constraint would delete the second route, and leave the first and third routes. Since the third route is both longer (10 hours versus 8 hours) and more costly (a weighted cost of 9 versus a weighted cost of 7), the first route would be ordered first.

In some embodiments, the charging station authorization system may account EVs that are serviced by flat-monthly fee pricing. For example, an eMSP may operate CPO #2. Use of CPO #2 charging stations may cost less than advertised prices. The charging station authorization system may route EVs with an affinity for CPO #2 charging stations to keep money within the CPO #2 charging stations, even if pricing may be higher, as that enables money collected from users of EVs to remain with the eMSP and justify the CPO #2 infrastructure. With an affinity for CPO #2 charging stations, the charging station authorization system may select route three using CPO #2 charging stations 216 and 218.

One or more of the ordered routes may be provided to a user device for route selection. After receiving route selection, the charging station authorization system may communicate with one or more CPOs to request charging authorization for each charging station along the route. For example, the charging station authorization system may communicate with an API of the CPO computing platform. The charging station authorization system may transmit a message to the CPO computing platform indicating a list of charging stations, an identifier of the EV, and credentials of the eMSP. The CPO computing platform may transmit authorization messages to management systems responsible for each of the charging stations indicating an authorization to charge an EV matching the identifier. The management systems may report charging the EV to the CPO computing platform, including statistics of the charge (e.g., amount, cost, time, etc.). The CPO computing platform may send an indicator and/or invoice to the eMSP computing platform for the charging of the EV 116.

In another embodiment, the charging station authorization system may be used to organize charging of EV used for distribution of goods or services. In an embodiment, the charging station authorization system may receive profile information of an EV, wherein the profile information comprises range data. The charging station authorization system may receive charging station information. The charging station information may comprise geographic location data and cost data. The charging station authorization system may receive a starting geographic location of the EV. The charging station authorization system may receive constraint data. The constraint data may comprise geographic location timing data. The geographic location timing data may comprise a set of geographic locations. Each geographic location from the set of geographic locations may be associated with a timing constraint. The charging station authorization system may determine, based on the geographic location timing data, a set of routes from the starting geographic location to each geographic location. Each route may comprise one or more charging stations that enable the EV to reach each charging station along the route based on the range data. The charging station authorization system may order, based on cost data of one or more charging stations included in a route, the set of routes. The charging station authorization system may recommend, based on the order, the first ordered route from the set of routes (e.g., the ordinally first route from the set of routes as ordered). The charging station authorization system may transmit, for use with the EV, the recommended route. The charging station authorization system may transmit a request to authorize charging of the EV with each of the charging stations included in a route from the set of routes indicated by the user route selection.

In some embodiments, the charging station authorization system may determine a set of routes by considering a SoC of the EV, which may be estimated or otherwise determined based on a current location of the EV and an initial location (e.g., a location where the SoC of the EV was last known).

In some embodiments, a distance between a current location and the initial location may be determined by a computing device. The distance may be determined by analyzing one or more map routes between the current location and the initial location and determining the distance of a most likely route. The most likely route may be, for example, the shortest distance route, the route avoiding one or more tolls, the route avoiding or using freeways, or the route having the shortest estimated travel time. The determined distance may be used as an estimate for a distance traveled by the vehicle along the actual route between the locations.

In some embodiments, the vehicle SoC at a location L1 is estimated by the computing device using the determined distance. In some embodiments, the vehicle SoC is estimated using the determined distance as well as one or more of an estimated SoC at the end of the vehicle's previous trip, an estimated SoC at the previous location, and/or one or more vehicle characteristics (e.g., mileage per kWh, battery size, battery charge capacity, etc.). For example, a user (e.g., vehicle driver or passenger) of the computing device may select one or more vehicle characteristics to specify a certain vehicle configuration that impacts the SoC determination. In another example, vehicle characteristics may be preselected for a particular vehicle and/or obtained from a third-party (e.g., a database of the vehicle manufacturer). In some embodiments, historical data for the vehicle is used alone or in conjunction with one or more of the determined distances, the estimated SoC at the end of the vehicle's previous trip or at the previous location, and the one or more vehicle characteristics, to estimate the SoC of the vehicle. The historical data may include one or more of distance traveled on one or more previous trips, mileage per kWh for one or more previous trips, vehicle energy use from operating air conditioning or heating for one or more previous trips, weather conditions from one or more previous trips, vehicle energy expenditure for one or more previous city driving trips, vehicle energy expenditure for one or more previous highway and/or freeway driving trips, and the like.

In some embodiments, the vehicle SoC estimation uses one or more of a trip distance, route, terrain information, time of day, day of the week, traffic, road condition, vehicle information, weather, and/or vehicle user driving behavior.

In some embodiments, the vehicle SoC is estimated by a model trained using data received (e.g., over Bluetooth or a network) by a computing device from the vehicle. In some embodiments, the model is a regression based machine learning model. In some embodiments, the model uses feedback to fine tune the estimated SoC. In some embodiments, the model uses one or more of distance traveled, vehicle information, an initial SoC, and/or other parameters to estimate SoC.

In some embodiments, a distance traveled by the vehicle may be determined using location data as discussed herein and is used to estimate SoC. In some embodiments, a hypothetical distance traveled by the vehicle for a future trip from a start location to end location may be determined and used to estimate SoC at the end location.

In some embodiments, vehicle information relevant to estimating SoC such as charging history, one or more charging patterns, and manufacturer specifications of the vehicle and/or battery may be registered by a user or retrieved from a third party (e.g., the vehicle manufacturer) and stored in the database, and a computing device may access the information to estimate SoC. In some embodiments, the vehicle information includes a charging profile of the vehicle's battery (e.g., obtained from the vehicle or from the manufacturer) that is used to estimate the SoC.

In some embodiments, an initial SoC is used to estimate the SoC. The initial SoC may be the initial state of the vehicle battery when the user starts driving or after completion of the last charging session. For example, the initial SoC may be based on an SoC measurement after completion of the last charging session and may account for parasitic power loss and other standby loss factors. In some embodiments, the last charging session is completed due to an end of charge (e.g., the battery is at capacity and cannot be further charged). In some embodiments, the last charging session is completed because a predetermined charge level (e.g., set by a user via the vehicle or a computing device) is met. In some embodiments, the initial SoC is input by a user via the vehicle or a computing device.

In some embodiments, the other parameters used to estimate SoC charge include one or more of the following: heating, ventilation, and air conditioning (HVAC) load for the vehicle (e.g., whether heating or air conditioning is on or off and patterns of usage), slope of the road or surface traveled by the vehicle, external weather parameters in the vicinity of the vehicle or at previous locations the vehicle traveled to or through (e.g., temperature, windspeed, etc.), vehicle speed during one or more previous trips, total time-taken between start and destination locations for one or more previous trips, total drive time during one or more previous trips, one or more stops made during one or more previous trips and frequency of stops, the type of route taken during one or more previous trips (e.g., city route, freeway, off-road, rural, etc.).

In some embodiments, the model that estimates the vehicle SoC uses machine learning to refine the model and provide improved vehicle SoC estimations as more data is obtained for a particular vehicle. In some embodiments, the model uses machine learning combined with online learning which fetches additional data as more relevant data becomes available to refine the model and provide improved vehicle SoC estimations.

The output of the model will be the estimated SoC. In some embodiments, the estimated SoC is of the current SoC. In some embodiments, the estimated SoC is an estimate of the vehicle's SoC at a future location, such as a trip destination. In some embodiments, a driver is notified of one or more of the vehicle SoC, degradation of the vehicle battery or SoC, an alert to charge when a charging station is located in a vicinity of the vehicle (e.g., within 1 mile, 5 miles, 10 miles) and the SoC is below a predetermined threshold, an alert for a low SoC (e.g., the SoC is below a predetermined threshold), and/or one or more route modifications for a trip based on the estimated SoC. The alerts may be provided to the vehicle, which may provide an audible notification sound and/or provide a notification window on a display or heads-up projection of the vehicle. The alerts may be provided to a computing device of a user (e.g., of the vehicle driver or a passenger), which may make an audible sound and/or provide a notification window on a display of the device.

In some embodiments, alone or in combination with the aspects noted above, the SoC of the vehicle is estimated using one or more of distance traveled, vehicle information, an initial SoC, and/or other parameters from one or more other vehicles that are not the vehicle. For instance, users associated with the one or more other vehicles may provide the database with access (e.g., via API credentials) to distance traveled, vehicle information, an initial SoC, and/or the other parameters, and the SoC for the vehicle may be estimated by the model by using this information of one or more other vehicles. In some embodiments, this information of the one or more other vehicles may be from a time when a charging session is completed for the other vehicle(s) and/or when a user configures the SoC manually for the other vehicle(s).

In some embodiments, the estimated SoC is transmitted by one or more of the computing device, or database to the charging station. In other embodiments, the charging station determines the estimated SoC for the vehicle itself at the location, using the processes discussed herein and the relevant data discussed above, which may be received by the charging station from one or more of the database and/or the computing device.

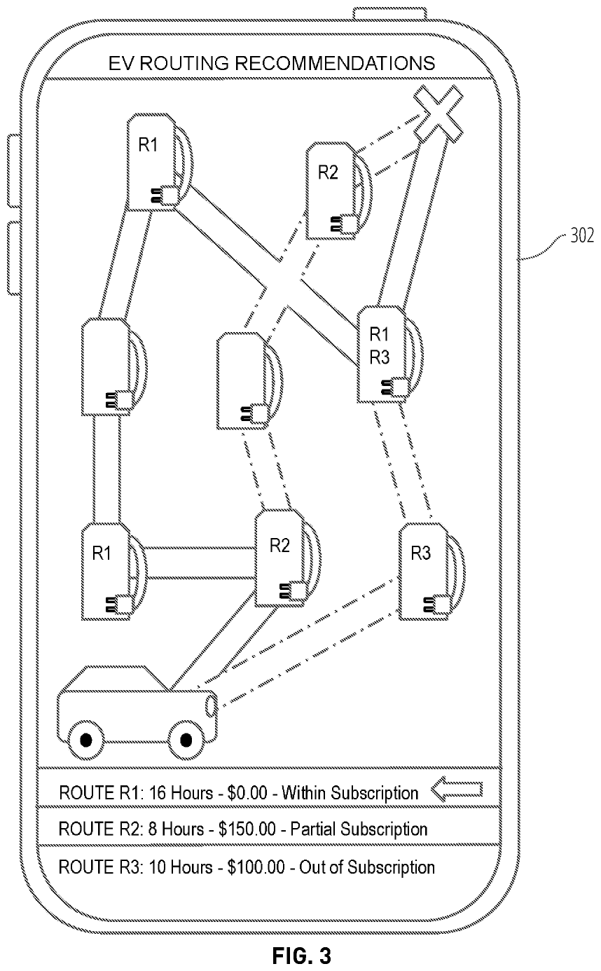

FIG. 3 shows an example of a mobile screen describing geographic routing options, according to some embodiments. After determining and ordering routes, the charging station authorization system may send, to a user device 302, the list of ordered routes. The user device 302 may render the routes and may provide route selection options to the user. The charging station authorization system may include additional information, including consequences of selecting a route. For example, if a user has a flat-rate subscription, the user device 302 may render information describing which routes are within the subscription, and which routes may require an extra charge due to being outside or partially outside of the subscription. In the embodiment shown, route r1 is within a subscription, route r2 is partially within a subscription and route r3 is outside of a subscription.

The user device may receive a user route selection. The user device may then transmit the user route selection to the charging station authorization system. In some embodiments, the charging station authorization system may be split across one or more computing devices. For example, a charging station authorization system may include a routing component that operates on a user device and a CPO platform authorization request component on an eMSP service computer. In other embodiments, the charging station authorization system may be contained in an application executing on a user mobile device.

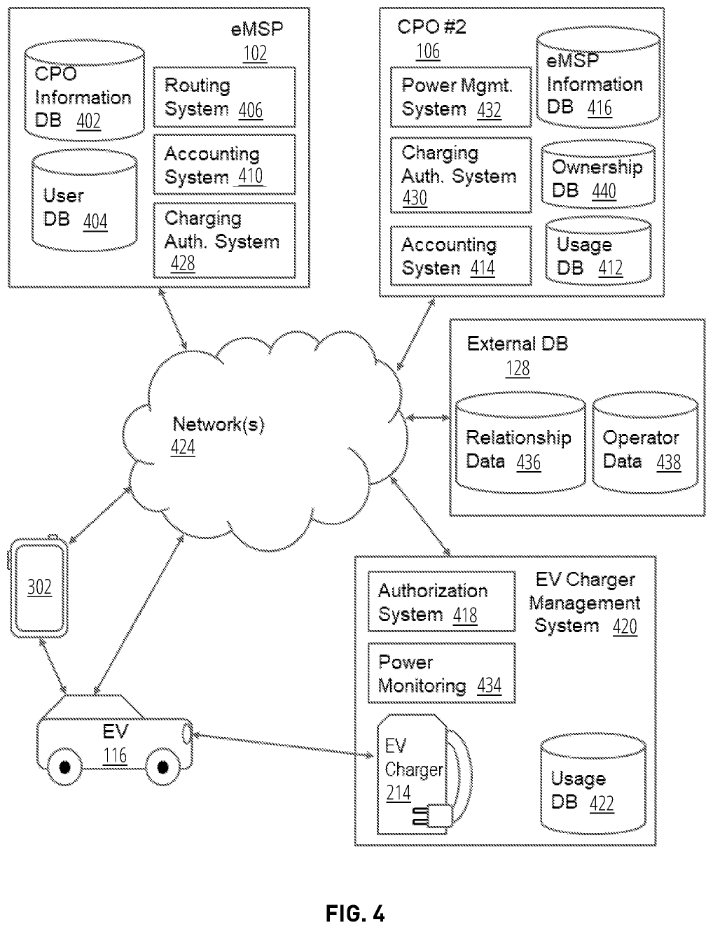

FIG. 4 shows a system diagram of a system providing electric vehicle charging authorizations, according to some embodiments. An eMSP 102 may communicate with an EV 116 or a user device 302 related to the EV 116 (e.g., a mobile device used by a driver of the EV, etc.). The EV 116 or user device 302 may transmit information to the eMSP 102 about one or more trips (e.g., travel, pickup and/or delivery of goods or services, etc.), including preferences and/or constraints. The eMSP 102 may provide a recommendation and/or routing options to EV 116 or user device 302. The EV 116 and/or the user device 302 may accept the routing and/or indicate a preferred route to eMSP 102. eMSP 102 may transmit to the CPO #2 106 a request for authorization to use one or more charging stations operated by the CPO #2 106. The CPO #2 106 may transmit an authorization to charge the EV 116 to an EV charger management system 420. The EV charger management system 420 may enable the EV 116 to charge at a charging station 214. The charging station 214 may provide charging information to the EV charger management system 420, including statistics describing the charging of the EV 116. The EV charger management system 420 may send all or part of the statistics to the CPO #2 106. The CPO #2 106 may report to and/or invoice the eMSP for the charging of the EV 116 at the charging station 214. Communications between systems may be via one or more networks 424 (e.g., Internet, cellular networks, private networks, power networks, wireless networks, etc.).

The eMSP 102 may comprise multiple components. The eMSP 102 may include a routing system 406, an accounting system 410, a charging authorization system 428, a CPO information database (DB) 402, and a user DB 404. The routing system 406 may use information including user profile information, CPO pricing information, CPO power network infrastructure capabilities, EV charging station locations, site power limitations, site current limitations, EV charging station capabilities (e.g., power delivery, estimated wait times, traffic, costs, power limitations, current limitations, etc.) map information, constraints, preferences, etc. to determine one or more routes and an order of recommendation of routes for EV 116 travel.

The accounting system 410 may enable tracking of usage, receipt of costs, billing of costs, and payment of vendors. For example, the accounting system may receive charging statistics from the CPO #2 106, receive invoices from the CPO #2 106, electronically pay the CPO #2 106, invoice for charging of the EV 116, track charging usage of the EV 116, and/or receive payments for charging usage of the EV 116.

The charging authorization system 428 may manage the charging and authorization or activation of charging stations along a route of the EV 116. The charging authorization system 428 may receive trip information from EV 116 or user device 302. The trip information, charging station information, and user profile information may be provided to the routing system 406. The routing system 406 may provide one or more routes to the charging authorization system 428. The charging authorization system 428 may communicate with the EV 116 or the user device 302 to approve and/or select a route. The charging authorization system 428 may then transmit a request to the CPO #2 106 to authorize charging of the EV 116 at one more charging stations 214.

The eMSP 102 may also contain one or more databases that enable the eMSP to provide services. The eMSP 102 may include a CPO information DB 402. The CPO information DB 402 may include relationship data relative to CPOs with which the eMSP 102 is formally (e.g., expressly) related, as described herein. The CPO information DB 402 may also include a copy of any operator data describing the network connectivity, ownership, or other right(s) to operate of the CPO #2 106 of, e.g., the charging station 214, in the manner described herein. The CPO information DB 402 may also describe statistics associated with CPOs and/or individual charging stations (e.g., costs, traffic, power delivery, number of charging stations, CPO power network infrastructure capabilities, site power limitations, site current limitations, etc.) that have been collected by the eMSP 102 over time. The eMSP 102 may include a user DB 404 that includes profile information describing users, preferences, account information, constraints, EVs 116, etc.

The CPO #2 106 may include multiple components. The CPO #2 106 may include a power management system 432, a charging authorization system 430, an accounting system 414, an eMSP information DB 416, an ownership DB 440, and/or a usage DB 412. The power management system 432 may manage infrastructure, including managing power costs, overages, maintenance, downtime, etc. The charging authorization system 430 may receive charging requests from the eMSP 102 and send charging authorizations to the EV charger management system 420. The accounting system 414 may receive charging statistics from the EV charger management system 420, store usage information in the usage DB 412, report charging usage of EV 116 to the eMSP 102, and/or invoice the eMSP 102 based on relationship or contract information in the eMSP information DB 416. The eMSP information DB 416 may include a copy of relevant relationship data (describing a relationship between the eMSP 102 and the CPO #2 106). The ownership DB 440 may include a copy of operator data (describing the network connectivity, ownership, or other right(s) to operate of the CPO #2 106 of the charging station 214). As described herein, these may be provided to the eMSP 102 in certain embodiments for use during routing.

The external DB 128 may include a copy of any relationship data 436 and/or any operator data 438 that may be accessed and subsequently used by the eMSP 102 in the manner described herein. The relationship data 436 and/or the operator data 438 may have been provided to the external DB 128 by the CPO #2 106 in some embodiments, or by an operator of the CPO #2 106 in some embodiments.

The EV charger management system 420 may comprise multiple components. The EV charger management system may include an authorization system 418, a power monitoring system 434, one or more charging stations 214, and a usage DB 422. The authorization system 418 may receive charging authorizations from the CPO #2 106, enable one or more charging stations 214 to charge an identified EV 116, and send usage statistics from the usage DB 422 to the CPO #2 106. The power monitoring system 434 may monitor one or more charging stations 214, collect statistics from the charging stations 214 to store in the usage DB 422, and manage charging infrastructure. The one or more charging stations 214 may charge one or more EVs 116, communicate with the EV 116 and/or associated user device 302 to enable charging, and provide charging statistics to the power monitoring system 434.

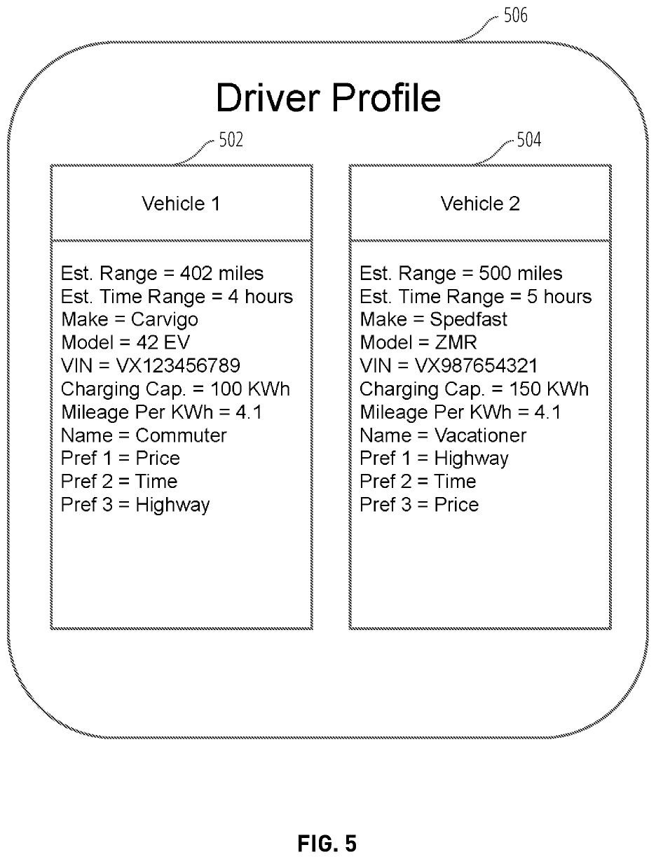

FIG. 5 shows a vehicle driver profile 506, according to some embodiments. A vehicle driver profile 506 may include preferences, constraints, and EV information. For example, in the embodiment shown, the vehicle driver profile 506 includes information describing two vehicles. Vehicle 1 data 502 may include information describing a commuter vehicle with a primary preference for price, a 402 mile range, and a charging capacity of 100 KWh, among other information. Vehicle 2 data 504 may include information describing a vacation vehicle with a primary preference for highways, a 500 mile range, and a 150 KWh charging capacity.

A driver profile 506 may contain vehicle information for a driver in accordance with some embodiments of the disclosure. In some embodiments, the driver profile 506 is stored in a database that communicates with a driver's computing device and/or vehicle and/or charging station used by the driver. In some embodiments, the driver profile is stored locally on a computing device. In some embodiments, the driver profile 506 is stored in an onboard computer memory of a vehicle (e.g., EV 116). In some embodiments, the driver profile 506 includes data regarding one or more vehicles owned by, leased by, or otherwise in possession of (e.g., rented by) a driver. In the embodiment shown, the driver profile 506 for driver 1 includes a vehicle 1 and a vehicle 2. Vehicle 1 has associated vehicle 1 data 502 which includes, for example, vehicle make, model, vehicle identification number (“VIN”), charging capacity, mileage per kWh, battery size, and MAC address. Vehicle 2 has associated vehicle 2 data 504 including similar information. It should be noted that more or less data may be included in each driver profile 506 and/or in data 502, 504. A driver profile may include additional information such as maximum charging power using AC charging, maximum current using AC charging, the maximum charging power using DC charging, maximum current using DC charging, plug types and statistics supported by the car (e.g., a plug may be the limiting factor—for example, Tesla cars may charge faster using a proprietary plug than when using CHAdeMO), a maximum DC charging voltage (e.g., 400V batteries may charge 50% slower than 800V batteries at a given current, which may cause power to be a limiting factor depending on a DC charger and/or the battery voltage), and/or DC and/or AC charging curves dependent on battery SoC and ambient temperature (for example, batteries may charge slower when being either heated or cooled, or when they are close to being full).

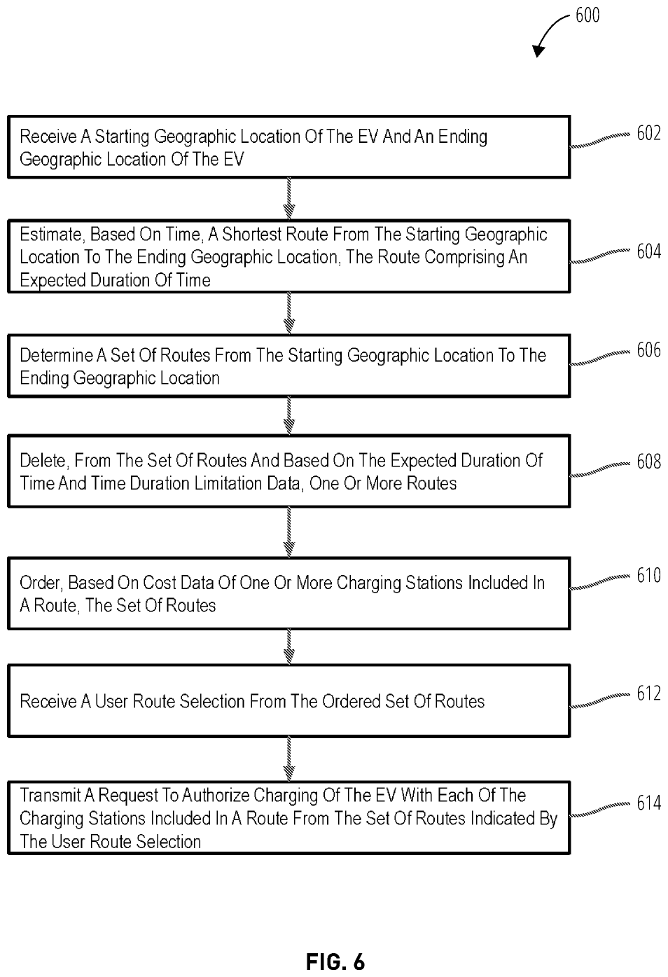

FIG. 6 shows a flow diagram of a process or method 600 of authorizing vehicle charging for an EV along a route from a starting location to a destination, according to some embodiments. The method 600 may be performed by one or more systems described above, including the eMSP 102, the CPOs 104, 106, the charging stations 108-114, the EV 116, and the EV charger management system 420 of FIG. 1 and FIG. 3. The charging station authorization system may receive or retrieve profile information of an EV, wherein the profile information comprises range data and constraint data, wherein the constraint data comprises time duration limitation data. The charging station authorization system may receive charging station information or retrieve charging station information from a DB. The charging station information may comprise geographic location data and cost data. In block 602, the charging station authorization system may receive a starting geographic location of the EV and an ending geographic location of the EV. In block 604, the charging station authorization system may estimate, based on time, a shortest route from the starting geographic location to the ending geographic location, the route comprising an expected duration of time. In block 606, the charging station authorization system may determine a set of routes from the starting geographic location to the ending geographic location. Each route may comprise one or more charging stations enabling the EV to reach each charging station along the route based on the range data. In block 608, the charging station authorization system may delete, from the set of routes and based on the expected duration of time and time duration limitation data, one or more routes. In block 610, the charging station authorization system may order, based on cost data of one or more charging stations included in a route, the set of routes. The charging station authorization system may transmit, for user selection, the ordered set of routes. In block 612, the charging station authorization system may receive a user route selection from the ordered set of routes. In block 614, the charging station authorization system may transmit a request to authorize charging of the EV with each of the charging stations included in a route from the set of routes indicated by the user route selection.

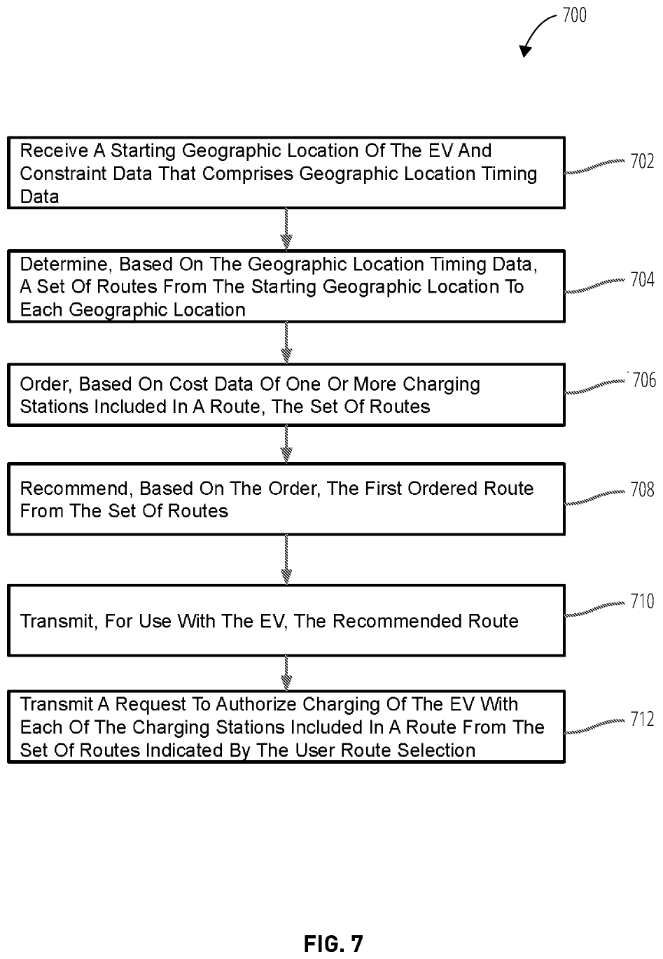

FIG. 7 shows a flow diagram of a process or method 700 of authorizing vehicle charging using geographical timing data, according to some embodiments. The method may be performed by one or more systems described above, including eMSP 102, CPOs 104, 106, charging stations 108-114, EV 116, EV charger management system 420 of FIG. 1 and FIG. 3. The charging station authorization system may be used to organize charging of EV used for distribution of goods or services. In an embodiment, the charging station authorization system may receive or retrieve profile information of an electric vehicle (EV), wherein the profile information comprises range data. The charging station authorization system may receive or retrieve charging station information from a DB or CPO. The charging station information may comprise geographic location data and cost data. In block 702, the charging station authorization system may receive a starting geographic location of the EV. The charging station authorization system may receive constraint data. The constraint data may comprise geographic location timing data. The geographic location timing data may comprise a set of geographic locations. Each geographic location from the set of geographic locations may be associated with a timing constraint. In block 704, the charging station authorization system may determine, based on the geographic location timing data, a set of routes from the starting geographic location to each geographic location. Each route may comprise one or more charging stations that enable the EV to reach each charging station along the route based on the range data. In block 706, the charging station authorization system may order, based on cost data of one or more charging stations included in a route, the set of routes. In block 708, the charging station authorization system may recommend, based on the order, the first ordered route from the set of routes. In block 710, the charging station authorization system may transmit, for use with the EV, the recommended route. In block 712, the charging station authorization system may transmit a request to authorize charging of the EV with each of the charging stations included in a route from the set of routes indicated by the user route selection.

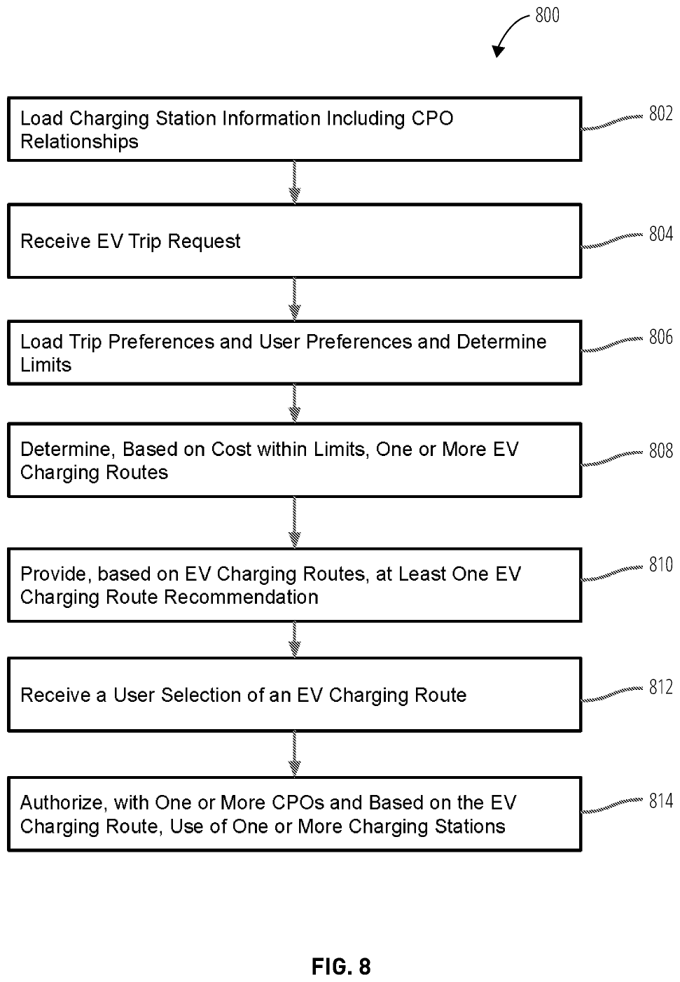

FIG. 8 shows a flow diagram of a process or method 800 of authorizing vehicle charging, according to some embodiments. The method may be performed by one or more systems described above, including eMSP 102, CPOs 104, 106, charging stations 108-114, EV 116, EV charger management system 420 of FIG. 1 and FIG. 3. In block 802, the charging station authorization system may load charging station information including CPO relationships. In block 804, the charging station authorization system may receive an EV trip request. In block 806, the charging station authorization system may load trip preferences and user preferences and determine constraints. In block 808, the charging station authorization system may determine, based on cost within limits, one or more EV charging routes. In block 810, the charging station authorization system may provide, based on EV charging routes, at least one EV charging route recommendation. In block 812, optionally the charging station authorization system may receive a user selection of an EV charging route. In block 814, the charging station authorization system may authorize, with one or more CPOs and based on the EV charging route, use of one or more charging stations.

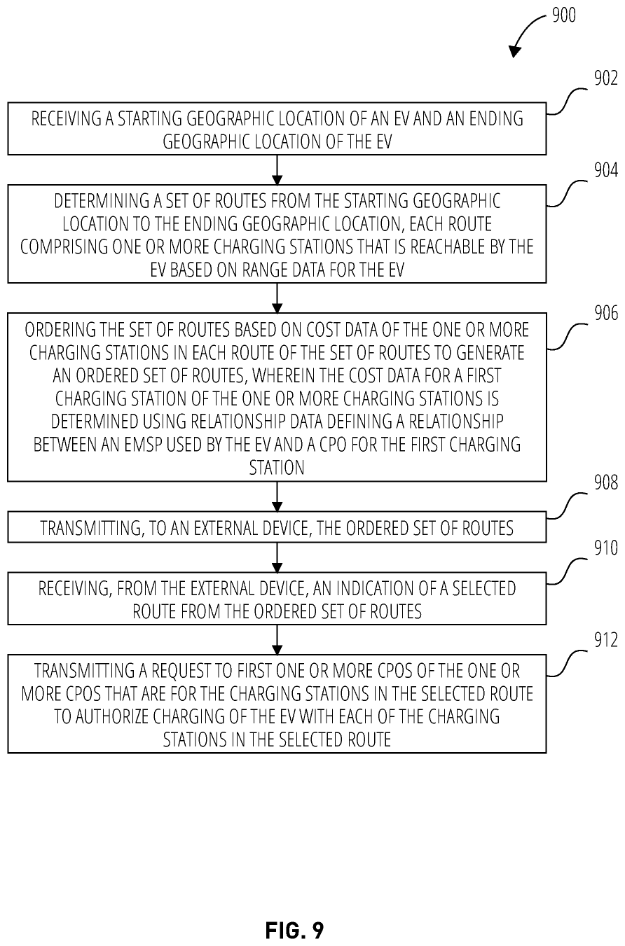

FIG. 9 illustrates a method 900 of a computing device for activating charging stations, according to an embodiment. The method 900 includes receiving 902 a starting geographic location of an EV and an ending geographic location of the EV.

The method 900 further includes determining 904 a set of routes from the starting geographic location to the ending geographic location, each route comprising one or more charging stations that is reachable by the EV based on range data for the EV.

The method 900 further includes ordering 906 the set of routes based on cost data of the one or more charging stations in each route of the set of routes to generate an ordered set of routes, wherein the cost data for a given charging station of the one or more charging stations is determined using relationship data defining a relationship between an eMSP used by the EV and a CPO for the given charging station.

The method 900 further includes transmitting 908, to an external device, the ordered set of routes.

The method 900 further includes receiving 910, from the external device, an indication of a selected route from the ordered set of routes.

The method 900 further includes transmitting 912 a request to first one or more CPOs of the one or more CPOs that are for the charging stations in the selected route to authorize charging of the EV with each of the charging stations in the selected route.

In some embodiments of the method 900, the cost data for the given charging station of the one or more charging stations is further determined using operator data indicating that the CPO for the given charging station may operate the given charging station.

In some embodiments of the method 900, the external device is the EV.

In some embodiments of the method 900, the external device is a mobile device of a user of the EV.

In some embodiments, the method 900 further includes selecting a first route in the ordered set of routes as a recommended route; and indicating, to the external device, the recommended route.

In some embodiments of the method 900, the request comprises an identifier of the EV and credentials identifying the eMSP.

In some embodiments, the method 900 further includes estimating, based on time, a shortest route from the starting geographic location to the ending geographic location, the shortest route comprising an expected duration of time; and deleting a first route from the set of routes based on a comparison of the expected duration of time and a duration of the first route.

In some embodiments, the method 900 further includes identifying that a first route of the ordered set of routes is within a subscription used by the eMSP; and transmitting, to the external device, an indication that the first route is within the subscription.

In some embodiments, the method 900 further includes receiving one of the relationship data and the operator data from an external database.

In some embodiments, the method 900 further includes

In some embodiments of the method 900, receiving one of the relationship data and the operator data from the CPO.

In some embodiments of the method 900, the computing device is included in the eMSP.

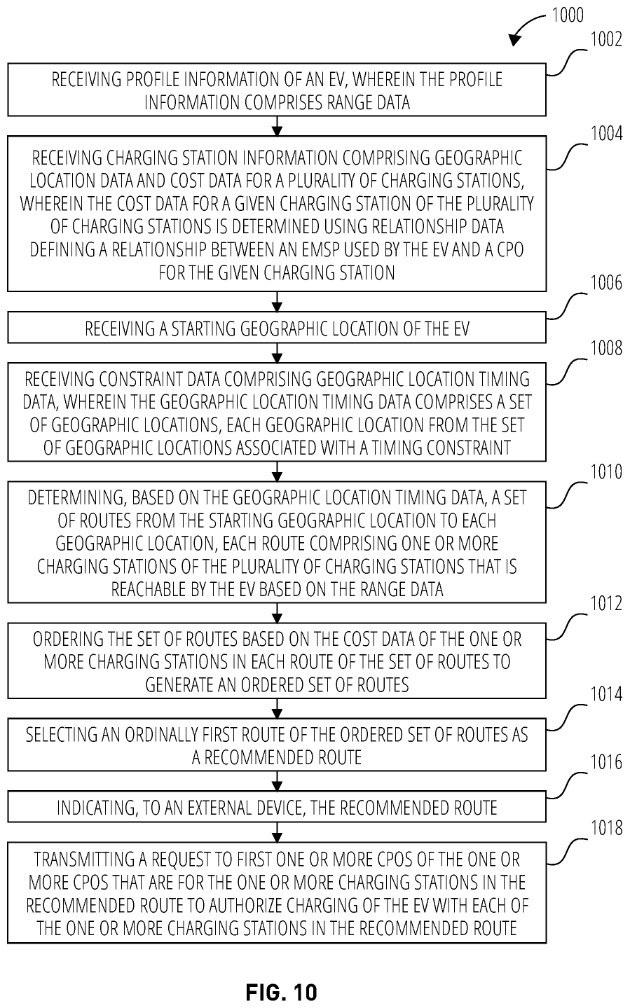

FIG. 10 illustrates a method 1000 of a computing device for activating charging stations, according to an embodiment. The method 1000 includes receiving 1002 profile information of an EV, wherein the profile information comprises range data.

The method 1000 further includes receiving 1004 charging station information comprising geographic location data and cost data for a plurality of charging stations, wherein the cost data for a given charging station of the plurality of charging stations is determined using relationship data defining a relationship between an eMSP used by the EV and a CPO for the given charging station.

The method 1000 further includes receiving 1006 a starting geographic location of the EV.

The method 1000 further includes receiving 1008 constraint data comprising geographic location timing data, wherein the geographic location timing data comprises a set of geographic locations, each geographic location from the set of geographic locations associated with a timing constraint.

The method 1000 further includes determining 1010, based on the geographic location timing data, a set of routes from the starting geographic location to each geographic location, each route comprising one or more charging stations of the plurality of charging stations that is reachable by the EV based on the range data.

The method 1000 further includes ordering 1012 the set of routes based on the cost data of the one or more charging stations in each route of the set of routes to generate an ordered set of routes.

The method 1000 further includes selecting 1014 an ordinally first route of the ordered set of routes as a recommended route.

The method 1000 further includes indicating 1016, to an external device, the recommended route.

The method 1000 further includes In transmitting 1018 a request to first one or more CPOs of the one or more CPOs that are for the one or more charging stations in the recommended route to authorize charging of the EV with each of the one or more charging stations in the recommended route.

In some embodiments of the method 1000, the cost data for the given charging station of the plurality of charging stations is further determined using operator data indicating that the CPO for the given charging station may operate the given charging station.

In some embodiments of the method 1000, the external device is the EV.

In some embodiments of the method 1000, the external device is a mobile device of a user of the EV.

In some embodiments of the method 1000, the request comprises an identifier of the EV and credentials identifying the eMSP.

In some embodiments of the method 1000, the geographic location timing data further comprises pickup information and delivery information.

In some embodiments of the method 1000, the profile information further comprises cargo capacity of the EV.

In some embodiments, the method 1000 further includes receiving one of the relationship data and the operator data from an external database.

In some embodiments, the method 1000 further includes receiving one of the relationship data and the operator data from the CPO.

In some embodiments of the method 1000, the computing device is included in the eMSP.

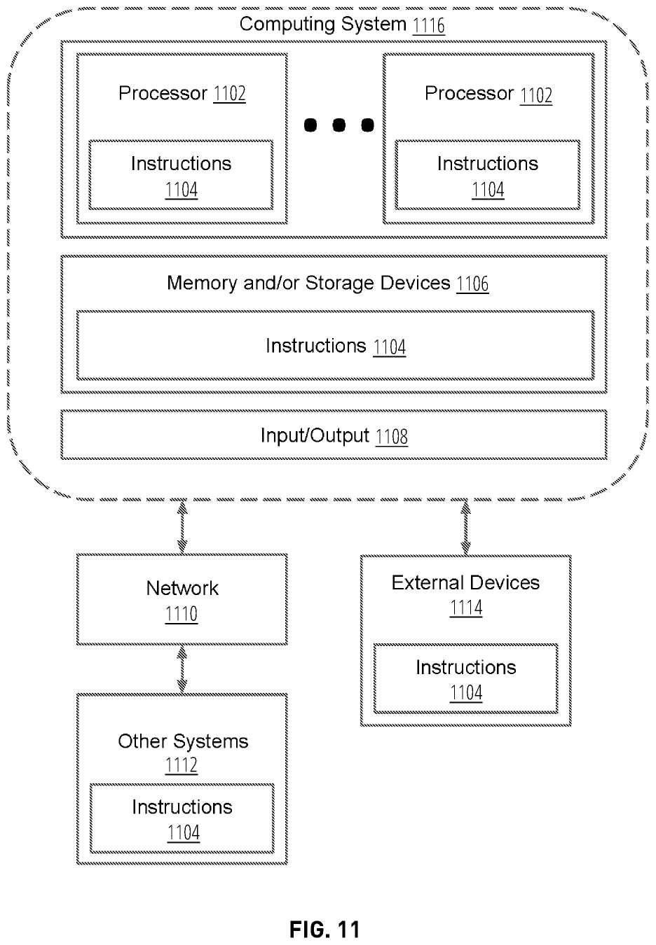

FIG. 11 shows a diagram of a computing system 1116 of a system providing electric vehicle charging authorizations, according to one embodiment. The computing system 1116 comprises one or more processors 1102 that execute instructions 1104. The computing system 1116 includes memory and/or storage devices 1106 that include instructions 1104 that may be executed by processors 1102. The computing system 1116 may include input/output systems 1108 that connect to a network 1110 and external devices 1114. External devices may include instructions 1104 executable by processors 1102. The computing system 1116 may be coupled to other systems 1112 via network 1110. Other systems may transmit instructions 1104 to computing system for execution by processors 1102.

In some embodiments, the memory and/or storage devices 1106 (each being a non-transitory storage medium, for example) may store instructions that are executable by a processor 1102 to implement the systems and methods described herein. For example, the instructions may be executable by a processor 1102 to implement any of the methods described herein (e.g., the methods shown in FIG. 6, FIG. 7, FIG. 8, FIG. 9, and/or FIG. 10).

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Descriptions is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

At least some embodiments may comprise a computer program product including a computer-readable storage medium having stored instructions and/or data thereon that may be used to program a computer (or other electronic device) to perform processes described herein. The computer-readable storage medium comprises at least a non-transient storage medium, such as, e.g., a hard drive, a fixed disk, a removable disk, a floppy diskette, an optical disk, a CD-ROM, a CD-RW, a DVD-ROM, a DVD-RW, a read-only memory (“ROM”), a random access memory (RAM), an erasable programmable ROM (EPROM), an electrically erasable programmable ROM (EEPROM), a magnetic card, an optical card, a solid-state memory device, or other types of media/machine-readable media suitable for storing electronic instructions and/or data.

A software module, module, or component may include any type of computer instruction or computer executable code located within a memory device and/or computer-readable storage medium, as is well known in the art. The software module, module, or component may execute in various environments, including via firmware, via a driver, via an application, on a local computing device, on a remote computing device, in a datacenter, and/or in a shared computing environment (e.g., a cloud computing environment).

It will be obvious to those having skill in the art that many changes may be made to the details of the above described embodiments without departing from the underlying principles of the invention.

1. A computing device for activating charging stations, comprising:
a processor; and
memory storing instructions that, when executed by the processor, cause the computing device to:
receive a starting geographic location of an electric vehicle (EV) and an ending geographic location of the EV;
determine a set of routes from the starting geographic location to the ending geographic location, each route comprising one or more charging stations that is reachable by the EV based on range data for the EV;
order the set of routes based on cost data of the one or more charging stations in each route of the set of routes to generate an ordered set of routes, wherein the cost data for a given charging station of the one or more charging stations is determined using relationship data defining a relationship between an electric mobility service provider (eMSP) used by the EV and a charge point operator (CPO) for the given charging station;
transmit, to an external device, the ordered set of routes;
receive, from the external device, an indication of a selected route from the ordered set of routes; and
transmit a request to first one or more CPOs of the one or more CPOs that are for the charging stations in the selected route to authorize charging of the EV with each of the charging stations in the selected route.

2. The computing device of claim 1, wherein the cost data for the given charging station of the one or more charging stations is further determined using operator data indicating that the CPO for the given charging station may operate the given charging station.

3. The computing device of claim 1, wherein the external device is the EV.

4. The computing device of claim 1, wherein the external device is a mobile device of a user of the EV.

5. The computing device of claim 1, wherein the instructions, when executed by the processor, further cause the computing device to:
select a first route in the ordered set of routes as a recommended route; and
indicate, to the external device, the recommended route.

6. The computing device of claim 1, wherein the request comprises an identifier of the EV and credentials identifying the eMSP.

7. The computing device of claim 1, wherein the instructions, when executed by the processor, further cause the computing device to:
estimate, based on time, a shortest route from the starting geographic location to the ending geographic location, the shortest route comprising an expected duration of time; and
delete a first route from the set of routes based on a comparison of the expected duration of time and a duration of the first route.

8. The computing device of claim 1, wherein the instructions, when executed by the processor, further cause the computing device to:
identify that a first route of the ordered set of routes is within a subscription used by the eMSP; and
transmit, to the external device, an indication that the first route is within the subscription.

9. The computing device of claim 1, wherein the instructions, when executed by the processor, further cause the computing device to receive one of the relationship data and the operator data from an external database.

10. The computing device of claim 1, wherein the instructions, when executed by the processor, further cause the computing device to receive one of the relationship data and the operator data from the CPO.

11. A method of a computing device for activating charging stations, the method comprising:
receiving profile information of an electric vehicle (EV), wherein the profile information comprises range data;
receiving charging station information comprising geographic location data and cost data for a plurality of charging stations, wherein the cost data for a given charging station of the plurality of charging stations is determined using relationship data defining a relationship between an electric mobility service provider (eMSP) used by the EV and a charge point operator (CPO) for the given charging station;
receiving a starting geographic location of the EV;
receiving constraint data comprising geographic location timing data, wherein the geographic location timing data comprises a set of geographic locations, each geographic location from the set of geographic locations associated with a timing constraint;
determining, based on the geographic location timing data, a set of routes from the starting geographic location to each geographic location, each route comprising one or more charging stations of the plurality of charging stations that is reachable by the EV based on the range data;
ordering the set of routes based on the cost data of the one or more charging stations in each route of the set of routes to generate an ordered set of routes;
selecting an ordinally first route of the ordered set of routes as a recommended route;
indicating, to an external device, the recommended route; and
transmitting a request to first one or more CPOs of the one or more CPOs that are for the one or more charging stations in the recommended route to authorize charging of the EV with each of the one or more charging stations in the recommended route.

12. The method of claim 11, wherein the cost data for the given charging station of the plurality of charging stations is further determined using operator data indicating that the CPO for the given charging station may operate the given charging station.

13. The method of claim 11, wherein the external device is the EV.

14. The method of claim 11, wherein the external device is a mobile device of a user of the EV.

15. The method of claim 11, wherein the request comprises an identifier of the EV and credentials identifying the eMSP.

16. The method of claim 11, wherein the geographic location timing data further comprises pickup information and delivery information.

17. The method of claim 16, wherein the profile information further comprises cargo capacity of the EV.

18. The method of claim 16, further comprising receiving one of the relationship data and the operator data from an external database.

19. The method of claim 16, further comprising receiving one of the relationship data and the operator data from the CPO.

20-23. (canceled)

24. A system for routing an electric vehicle (EV), comprising:
a processor; and
memory storing instructions that, when executed by the processor, cause the computing device to:
receive a starting geographic location of the EV and an ending geographic location of the EV;
determine a set of routes from the starting geographic location to the ending geographic location, each route comprising one or more charging stations that is reachable by the EV based on range data for the EV;
order the set of routes based on cost data of the one or more charging stations in each route of the set of routes to generate an ordered set of routes, wherein the cost data for a given charging station of the one or more charging stations is determined using relationship data defining a relationship between an electric mobility service provider (eMSP) used by the EV and a charge point operator (CPO) for the given charging station; and
transmit, to a computing device associated with the EV, the ordered set of routes.

25. The system of claim 24, wherein the cost data for the given charging station of the one or more charging stations is further determined using operator data defining a relationship between the CPO for the given charging station and the given charging station.

26. The system of claim 24, wherein the instructions, when executed by the processor, further cause the computing device to:
select a first route in the ordered set of routes as a recommended route; and
indicate, to the external device, the recommended route.
